(19) United States
(12) Patent Application Publication
(10) Pub. No.: US 2009/0106225 A1
(43) Pub. Date: Apr. 23, 2009

(54) IDENTIFICATION OF MEDICAL PRACTITIONERS WHO EMPHASIZE SPECIFIC MEDICAL CONDITIONS OR MEDICAL PROCEDURES IN THEIR PRACTICE

(76) Inventors: Wade S. Smith, Larkspur, CA (US); Janeen Elaine Smith, Larkspur, CA (US); Todd Schneider, Larkspur, CA (US)

Correspondence Address: WINSTON & STRAWN LLP;PATENT DEPARTMENT, 1700 K STREET, N.W., WASHINGTON, DC, 20006, US

(21) Appl. No.: 11/875,490

(22) Filed: Oct. 19, 2007

(51) Int. Cl. G06F 17/30; G06F 17/00

(52) U.S. Cl. 707/5; 707/102

(57) ABSTRACT

A scheme enables the identification of medical professionals having expertise with a particular medical condition or procedure. Areas of expertise are assigned to both conditions and procedures and medical professionals who treat the condition or perform the procedure. A description for treatment is received and used to identify a specific condition or procedure. Upon identification of the condition or procedure, the areas of expertise assigned to the condition or procedure are retrieved. Medical professionals who also have assigned one or more of the retrieved areas of expertise are then identified.

### BACKGROUND OF THE INVENTION

1. Field of Invention

This invention relates to the identification of medical practitioners who emphasize a particular medical condition or medical procedure in their professional medical practice.

2. Description of Prior Art

Individuals who need to find a medical practitioner often start their search with a particular medical condition or medical procedure in mind. For example, an individual may need to find a doctor who emphasizes strokes in his/her professional practice. This search process can be difficult because the individual may not understand the medical details relating to the medical condition. For instance, the individual may not understand that neurologists are typically the type of doctors who specialize in treating strokes. Even if an individual finds a neurologist, there is no easy way of knowing whether the neurologist treats more stroke or migraine patients, since both are conditions typically treated by a neurologist. Individuals also often have little familiarity with board certifications and medical terminology.

Health maintenance organizations and medical practitioner cooperatives also routinely assist individuals with finding physicians based on conditions or procedure, or refer individuals to physicians with the suitable emphasis within their referral network for care. The inefficiency or inability to find doctors based on their actual areas of focus for specific conditions or procedures results in a high number of second opinions required to treat a disease or perform a procedure, thus lengthening the care process and increasing overall costs.

An individual faced with this problem today can use general purpose search engines publicly available on the Internet, including Google, Ask Jeeves, MSN.com, and Alexa. General-purpose search engines typically index webpages and other online documents and information, which is used to match a user information query, such as natural-language keywords, to the indexed documents that are returned as a ranked list of search results. Although such general-purpose search engines may find information on a particular condition or procedure, many of the returned results will likely be irrelevant. For example, a search for “stroke” (along with “doctor” or “physician” keywords) may return webpages on general medical information on strokes not relevant to finding a suitable physician, swimming strokes (i.e., “swimming stroke doctor”), books on strokes for purchase, and articles written about strokes. While such information may be useful, it is inefficient and unlikely to help the individual find an actual doctor who specializes in treating strokes. Thus, it is important to provide users with search functionality specific to medical practitioners and their areas of emphasis.

Unlike general-purpose search engines, there are other prior systems that are specifically designed for finding doctors. “Health Grades” is one such prior example; however, Health Grades and other similar services only list medical practitioners by areas of specialty, like neurology, not by condition or procedure, such as “strokes”. Furthermore, these types of search engines do not provide the user with information on the areas a doctor focuses on within a particular field of medical specialty (i.e., whether a neurologist focuses more on strokes versus migraines, or vice versa).

Other prior systems such as “Revolution Health” (revolutionhealth.com) specifically designed for finding physicians do allow users to search by conditions or procedures. Although these systems are in some respects easier to use, they are still deficient because they do not capture information of a physician's particular areas of emphasis. This type of search engine might find neurologists when a user searches for “stroke”, but again the user has no easy way of determining whether a particular neurologist focuses on strokes rather than other areas such as migraines. Moreover, a doctor may split his/her time between multiple areas (for instance, a doctor may spend 60% of his/her time on strokes and 40% on migraines).

In general, none of the prior systems enable a user to understand what types of patients a particular physician typically treats, or what procedures they typically perform. Although medical practitioners can be distinguished by their particular training and board certification, there is no classification scheme available that characterizes, and utilizes thereafter, what medical practitioners actually do with the bulk of their time.

### SUMMARY OF THE INVENTION

According to an embodiment of the present invention, a method is provided for identifying medical professionals having expertise with a particular medical condition or procedure. To identify suitable medical professionals, areas of expertise may be assigned to both conditions or procedures and medical professionals. When a user seeks to find a medical professional, the user may provide a description of the treatment desired, which can be used to identify the medical condition or procedure. Subsequently, the areas of expertise assigned to the identified condition or procedure may be retrieved and used to find medical professionals who also have one or more of those areas of expertise.

Areas of expertise include well-known medical specialties and/or sub-specialties and areas of emphasis as defined or selected by individual medical professionals. Percentages of effort may be attached to each assigned area of expertise if the medical professional allocates only a portion of his/her time to that particular expertise. The description provided by the user could be a query with one or more keywords. It is also possible to expand the query with other similar keywords, or replace the query with similar queries used in the past.

Medical professionals identified may be ranked based on the number of areas of expertise he/she has in common with the condition or procedure being searched. Different types of expertise can be assigned different weights to express how relevant, useful, or accurate one type of expertise is compared to another. These weights may be used in conjunction with the number of overlapping areas of expertise to calculate a numerical score for each identified professional for use in ranking the final results. The scores can also be scaled if the professional has assigned percentages of effort for one or more of the overlapping areas of expertise.

When producing the final list of professionals for display to the user, the professionals may be grouped by the different types of expertise. The calculation of a statistical distribution for each group of identified professionals can be used to eliminate certain physicians. Physicians can also be removed if their scores do not meet a minimum score.

### BRIEF DESCRIPTION OF THE DRAWINGS

FIG. 1 shows a block diagram of assigning area(s) of expertise to a medical condition or procedure according to an embodiment of the present invention.

FIG. 2 shows a block diagram of assigning area(s) of expertise to a medical professional according to an embodiment of the present invention.

FIG. 3 shows a flowchart for a identifying a medical condition or procedure according to an embodiment of the present invention.

FIG. 4 shows a flowchart for identifying medical professionals according to an embodiment of the present invention.

FIG. 5 shows an example of a user query.

FIG. 6 shows an example conditions and procedures identified by the example user query of FIG. 5.

FIG. 7 shows an alternative example of FIG. 6 further illustrating synonyms according to an embodiment of the present invention.

FIG. 8 shows an example of medical specialists according to an embodiment of the present invention.

FIG. 9 shows an example of a physicians search results page.

FIG. 10 is an alternative example of FIG. 9 further showing each physician's score according to an embodiment of the present invention.

FIG. 11 is an example of a physicians search results page that is limited to a specific medical specialty according to an embodiment of the present invention.

### DETAILED DESCRIPTION OF THE PREFERRED EMBODIMENTS

Therefore, there is a need for a search engine that is specific to finding medical practitioners and their particular areas of emphasis. There is also a need to map medical conditions and procedures to the medical practitioners who emphasize the condition or procedure.

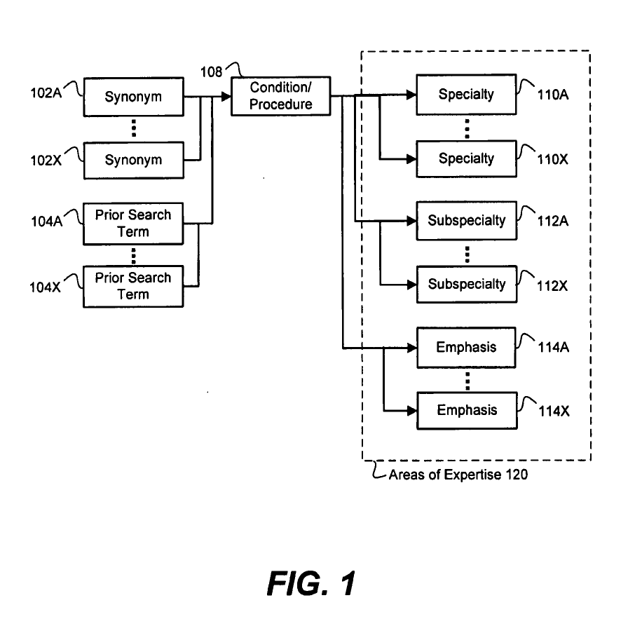

FIG. 1 shows a block diagram of assigning area(s) of expertise to a medical condition or procedure according to an embodiment of the present invention. Medical condition or procedure 108 can be identified from many different sources, including from individuals who have a particular condition or procedure for which they seek treatment. One source of reference conditions/procedures is a well-known and generally accepted taxonomy of medical conditions and procedures that can be used to identify a particular condition or procedure. Usage of a reference taxonomy is preferential, although not necessary, and has the advantage of increased uniformity because two individuals could describe the same condition or procedure with different terms, and the use of a common taxonomy can map both individual descriptions to the same condition or procedure. One example of such a taxonomy is the Medical Subject Heading (“MESH”), which is a comprehensive catalog of procedures and conditions that has been created by the National Library of Medicine (“NLM”) for public use, and is available online at http://www.nlm.nih.gov/mesh/MBrowser.html. This taxonomy organizes all medical conditions and procedures as MESH nodes in a hierarchy from general category to specific condition and procedure. The NLM also provides textual descriptions for the conditions and procedures in MESH.

Once a source of conditions and procedures is chosen, each condition or procedure 108 is associated to one or more areas of expertise 120. This association indicates that a particular condition or procedure is related to a particular area of medical expertise. For example, the condition could be “stroke” and an associated area of expertise could be “neurology”, which is a medical specialty that treats strokes. An example of expertise that can be associated with conditions or procedures is medical specialties 110A-110X; related to specialties are medical sub-specialties 112A-112X. Specialties and sub-specialties may be defined by a recognized medical organization, again for increased uniformity. In an embodiment, specialties can be defined by the American Board of Medical Specialty (“ABMS”) with each specialty representing an area of residency training. Sub-specialties are also defined by ABMS but may be defined by other certification entities, like the United Council of Neurological Subspecialties (“UCNS”). Associating specialties 110A-110X and sub-specialties 112A-112X to a condition or procedure 108 indicates that the associated specialties and/or sub-specialties may be appropriate for treating the particular condition or performing the particular procedure. As described above, users can provide descriptions to identify or select conditions and procedures; the words used in these descriptions can be recorded as prior search terms 104A-104X and their synonyms can be recorded as synonyms 102A-102X. Both prior search terms 104 and synonyms 102 can be linked to the condition or procedure 108 such that the condition or procedure can be easily identified in the future if any of these search terms or synonyms are used.

Often specialties and sub-specialties may not be sufficient to completely or accurately capture a physician's areas of expertise. Returning to our example, a doctor may be a board-certified neurologist but may not focus on strokes because he/she primarily treats migraines. Physician-defined areas of emphasis 114A-114X can be used to further capture this missing information. Areas of emphasis (or “emphasis nodes”) are specializations and or emphases within the practice of medicine that overlap areas of specialty and sub-specialty and therefore may be areas of focus for medical practitioners with a range of training. Breast cancer, or spine care are two examples of areas of emphasis.

The process of “associating” a condition or procedure to an area of expertise can be done in many different ways. For example, an area of expertise can be assigned or linked to a condition or procedure through relational databases where each area of expertise is an entry in a database table and each condition or procedure is an entry in a separate database table. Areas of expertise can also be assigned or linked to conditions or procedures through indices, mark-ups (such as XML) or other similar formats and methods.

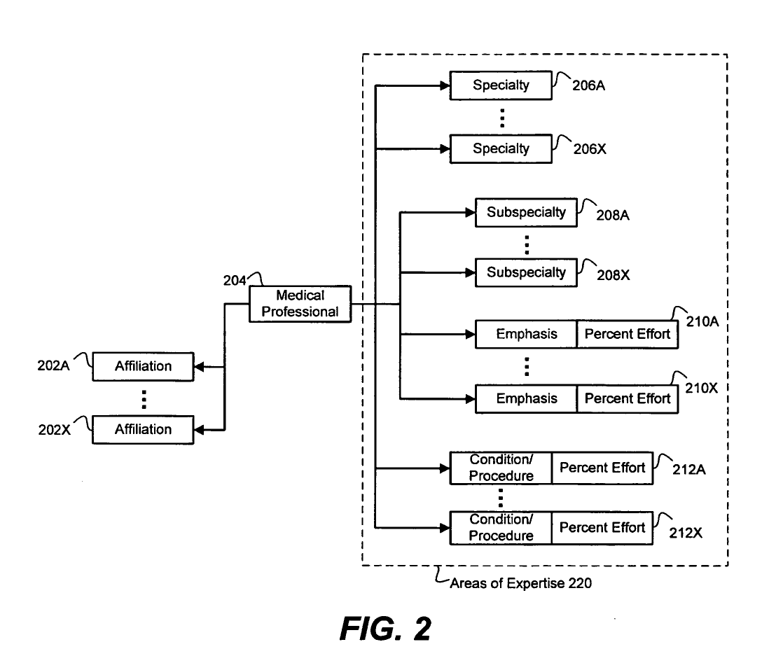

FIG. 2 shows a block diagram of assigning area(s) of expertise 220 to a medical professional 204 according to an embodiment of the present invention. Medical professional 204 may be a physician within a geographical boundary, in a particular medical center or university, or within a medical organization network, or some other similar category (or no category at all). Each medical professional 204 and his or her demographic data can be referenced by a unique medical practitioner ID. Each medical professional 204 can belong to one or multiple affiliations, such as practice and hospital groups, geographic regions, medical societies, or a non-profit organizations, and this reference is maintained by pointers to an affiliations database 202A-202X, if databases are used in the implementation.

Similar to associations shown in FIG. 1, each medical professional 204 is linked to or assigned with one or more areas of expertise 220, including specialties 206A-206X, sub-specialties 208A-208X, emphasis nodes 210A-210X, and also conditions or procedures 212A-212X. An association with a condition or procedure is the most direct indication that medical professional 204 treats the condition or performs the procedure. Although medical practitioners are typically certified in only one specialty and some have a sub-specialty, multi-boarded medical practitioners do exist in practice and therefore a one-to-many relationship structure is defined. Likewise, medical practitioners may also choose to focus on one or a few areas of medical emphasis. When more than one area of expertise makes up a medical practitioner's practice, a percent effort within that area of expertise may be assigned and attached to the expertise.

Medical professional association to specialty and subspecialty can be obtained by medical professional self-entry, by interview of medical professional practices or from lists provided from the ABMS, UCNS, and/or other medical organizations. Emphasis node and condition or procedure associations can be obtained similarly by interview of medical professionals. In addition, a medical professional's associations to other areas of expertise can be examined and analyzed to identify likely emphasis nodes, conditions or procedures, and other potential areas of expertise for association; these potential associations can be either automatically recorded or presented to the medical professional for confirmation and selection. Methods for this type of analysis include clustering, information extraction, statistical association calculations, and the use of expert domain knowledge (such as in expert systems).

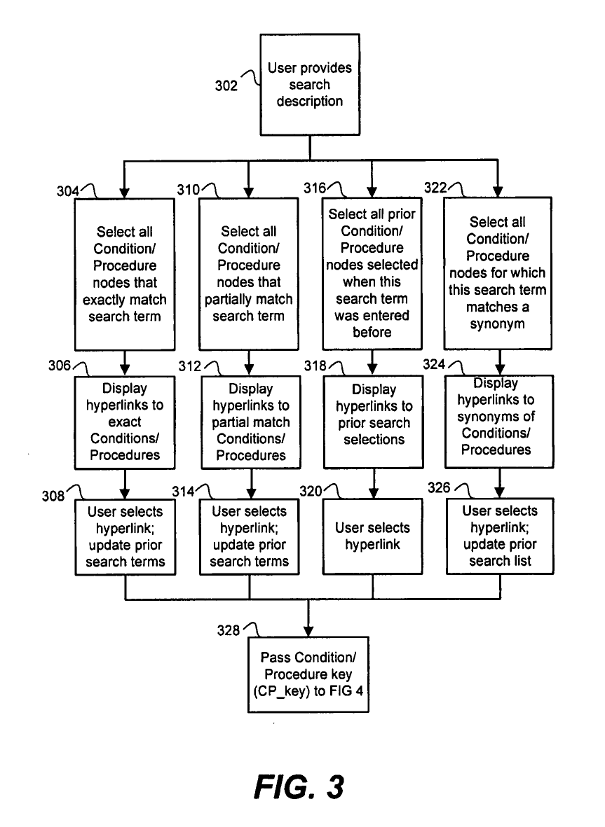

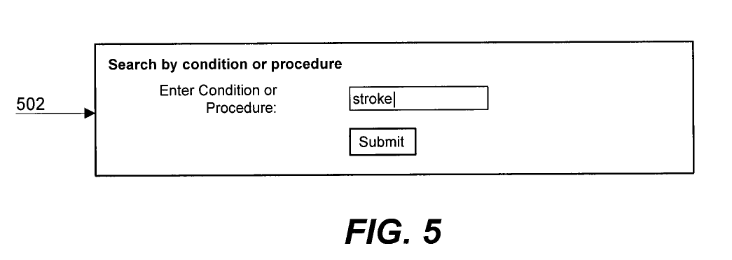

FIG. 3 shows a flowchart for a identifying a medical condition or procedure according to an embodiment of the present invention. A user begins the process by providing a search description 302 describing a specific condition or procedure. Description 302 can be in the form of a search query comprised of natural-language keywords, or longer textual descriptions. The description 302 may be solicited via a web page or an enterprise-level application whereby a user is asked to enter or provide the description, and press a “submit” button as in FIG. 5. Description 302 is then used to identify the condition or procedure. First, description 302 is used to query for exact matches of a condition or procedure, shown in step 304. For example the condition “Cerebrovascular Accident” could be found by entering “Cerebrovascular Accident” as description 302. A condition or procedure can also be found by partial match, shown in step 310. All of the exact and partial matches identified can be displayed to the user, as shown in steps 306 and 312. This can be in form of hyperlinks to MESH nodes if implemented using MESH in an online web application.

In addition, each individual search term in description 302 can be parsed and if any of these parsed search terms match any prior search terms 104, then the conditions or procedures linked to the prior search terms 104 can be used to create a supplement list, as shown in step 316. This supplemental list can be a reverse sorted list based on frequency of selection by the users of each condition or procedure in the supplemental list and displayed in step 318 as a “Most commonly selected list”. The parsed search terms can also be checked against synonyms 102, and if any of these parsed search terms match any synonyms 102, then the conditions or procedures linked to the synonyms 102 can be used to create an additional supplemental list, as shown in step 322. Similar to the prior search terms supplemental list, the synonyms supplemental list can also be sorted in reverse order based on frequency of selection and displayed in step 324 as a “Synonyms list”. In some embodiments, the initial list can be merged with any supplemental lists to produce one single list, or kept separate to provide more organization for the user.

Upon selection of a specific condition or procedure from the lists by the user in steps 308, 314, 320, or 326, any prior search term lists being maintained can be updated, as shown in steps 308, 314 and 326. For example, each parsed search term in the search description 302 can be added as prior search term 104 and linked to the user selected condition or procedure; if the parsed search term already exists as a prior search term 104, then its frequency of use can be incremented and used for ranking the prior search terms. Similarly, if the user selects a synonym in step 326, that synonym selected can be added as a new prior search term (or if already existing, its frequency incremented).

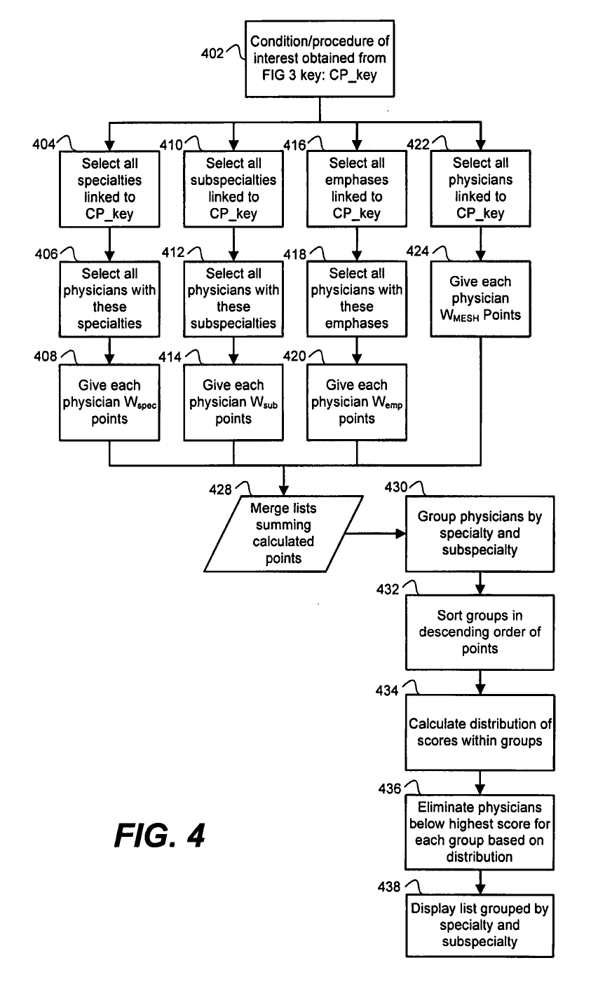

FIG. 4 shows a flowchart for identifying medical professionals according to an embodiment of the present invention. The condition or procedure selected in step 328 is passed in as CP_key 402. In general, areas of expertise, and in particular emphasis nodes, function as a bridge to link conditions and procedures to relevant medical professionals. A number of queries can be initiated using CP_key 402 to create this bridge. FIG. 4 shows four example queries, 404, 410, 416, and 422. Query 404 identifies all medical practitioners 406 who have specialties in common with CP_key 402. Query 410 identifies all medical professionals 412 with sub-specialties in common with CP_key 402. Query 416 identifies all medical professionals 418 with emphasis nodes in common with CP_key 402. Query 422 identifies all medical professionals who are linked directly to CP_key 402. Although four queries are shown in FIG. 4, one skilled in the art would understand that more or less queries can be performed depending on the different types of expertise utilized in the particular system. Query steps 404, 410, 416, and 422 are performed with the association information between conditions and procedures and areas of expertise as shown in FIG. 1, which may be pre-computed before these steps in FIG. 4, or computed in a dynamic manner during the steps of FIG. 4 with additional processing. Similarly, physician selection steps 406, 412, 418, and 424 are performed with the association information between medical professionals and areas of expertise as shown in FIG. 2, which may be pre-computed before theses steps in FIG. 4, or computed in a dynamic manner during the steps of FIG. 4 with additional processing.

For each query, a weighting of linkage is defined in order to give more significance to certain types of expertise. The preferred embodiment assigns a higher weight (i.e., more significance) to sub-specialty over specialty, emphasis over specialty and sub-specialty, and direct linkage to conditions or procedures over the other three. These weights Wspec assigned in step 408, Wsub assigned in step 414, Wemp assigned in step 420, and WMESH assigned in step 424 are preferably functions or constants derived by iterative refinement of the search results based on expert opinion and focus group feedback. It is well-understood that these weights can also be determined through machine learning techniques or other statistical or probabilistic methods, and can be ranked and weighted differently depending on the specific domain. Additionally, each weight can be scaled by the percentage effort for the particular assigned to the particular area of expertise, if any.

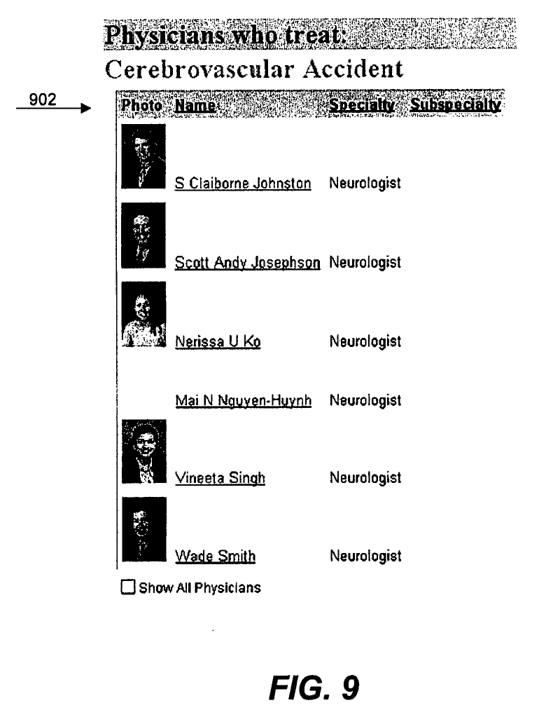

The four queries can then be merged into one list summing the points (derived from the weights for each query) so that each medical professional is assigned a numeric score called the expertise score. This score is proportional to physician relevance for the condition or procedure (CP_key) of step 402. Medical professionals can also be sub-grouped by specialty and sub-specialty, as shown in step 430, which can be used to allow the user to filter the physician search results to display by specialty of sub-specialty, as shown in example 802 (the listing 902 in FIG. 9 is a further example of filtered results following a user's selecting “Neurologist” from example 802).

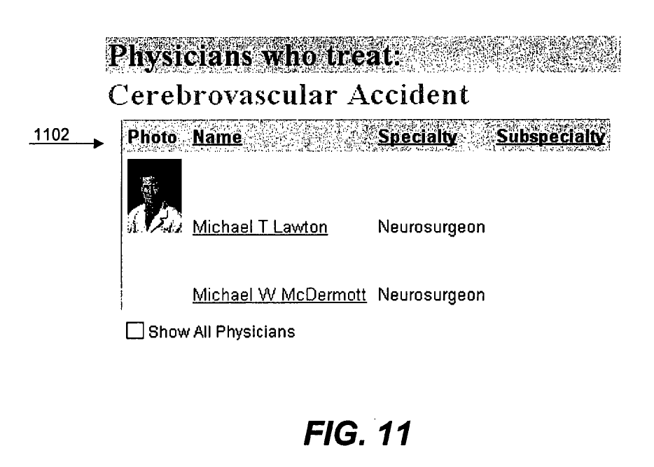

In the preferred embodiment, two lists of physicians can be displayed based on user selection: (1) a list of top scoring physicians, with a cut-point defined by the distribution of scores, or (2) a list of all doctors within the selected specialty or subspecialty sorted in reverse order of expertise scores, as shown in results 1002. In the example 1002, the expertise scores for each doctor is normalized to the highest overall score for the displayed group, then converted to a percent score and shown in reverse order, and alphabetically within identical score ranks. To show the list of top scoring physicians only, a numeric cut-point is determined based on the distribution of overall expertise scores and only medical practitioners meeting or exceeding this cut-point are retained. Examples for Neurologists and for Neurosurgeons are shown in FIGS. 9 and 11 as illustration. The selection of a numeric cut-point can based on the number of medical professionals within the group, and if more than several, it is based on the distribution of these scores. For Gaussian distribution of scores, medical professionals with scores one standard deviation and above the mean score may be retained. For highly skewed distributions with a single high outlier, it may be reasonable to retain only the top score, and for single or few low outliers, all the medical professionals with top scores can be retained. For flat distributions, all physicians may be shown. In example 902, the expertise scores are not displayed as compared to example 1002 in order to convey that this group of physicians are equally relevant.

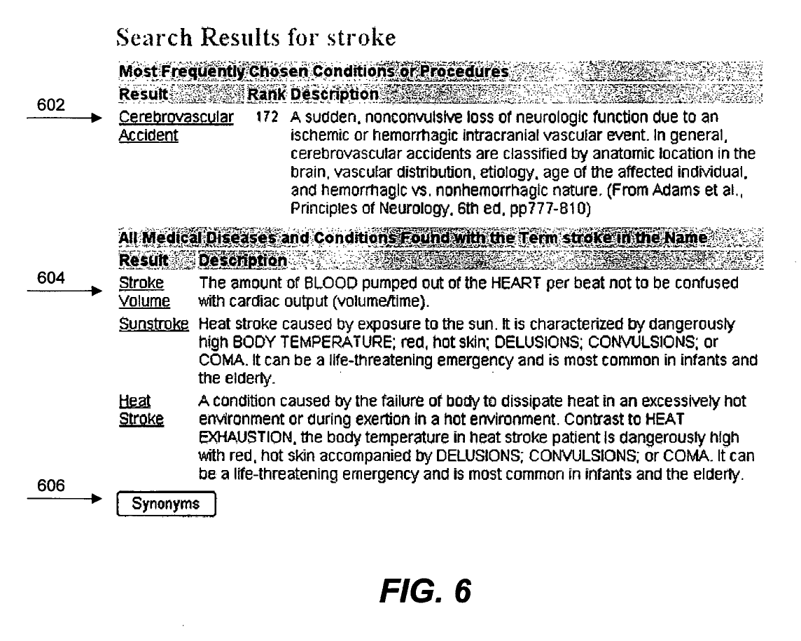

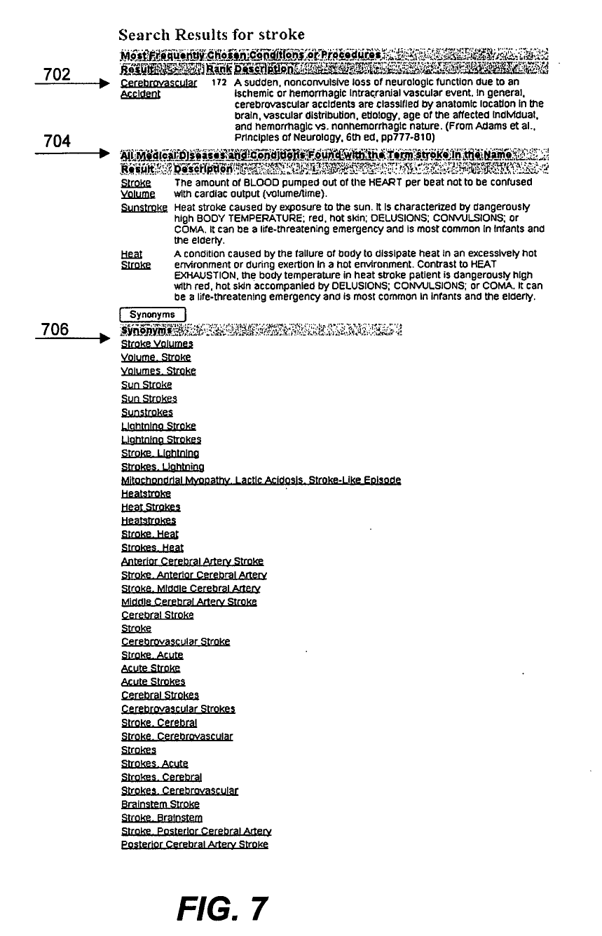

FIG. 5 shows an example of an user interface where “stroke” 502 is entered as a search description. FIG. 6 shows an example of conditions and procedures identified by the example user search description 502. Section 602 shows conditions or procedures that may be identified through prior search terms 104 in step 318. Section 604 shows conditions or procedures that may be identified through exact or partial search term matches in steps 304 and 310. All list groups can be sorted alphabetically; prior searches 602 may also be ranked in reverse order based on the frequency of use. Synonyms button 606 can be selected to display synonyms or other similar search terms based on the search term “stroke” in description 502. FIG. 7 shows an alternative example further illustrating synonyms when the synonyms button 606 is pressed.

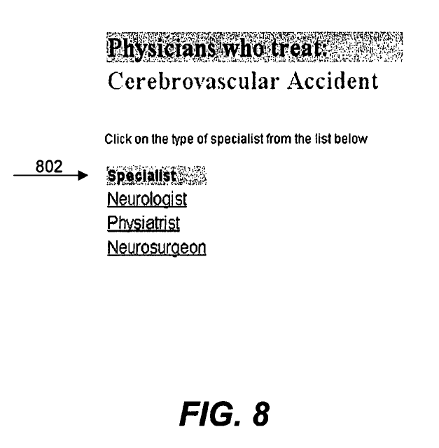

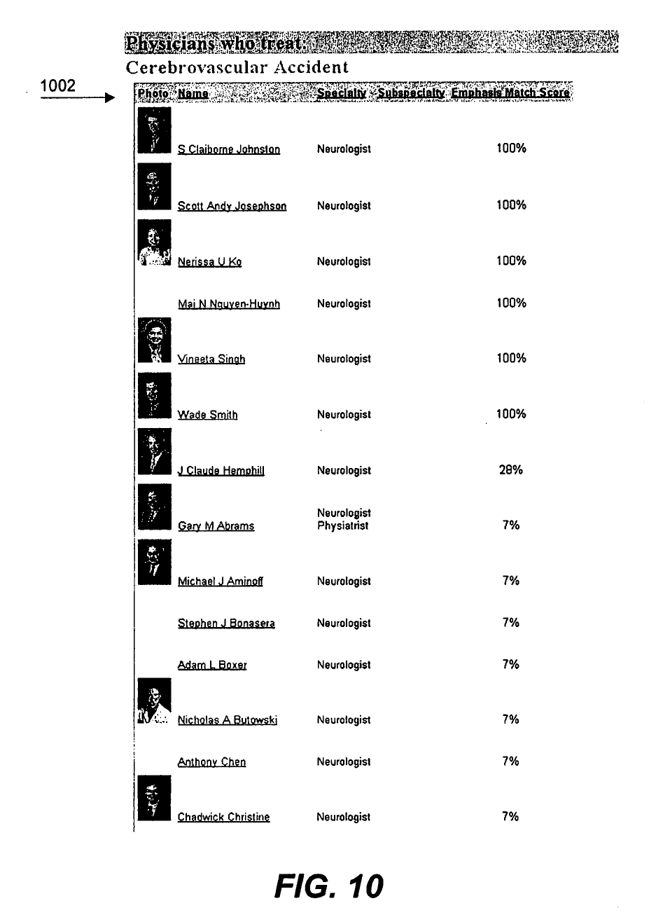

FIG. 8 shows an example of medical specialists according to an embodiment of the present invention. List 802 shows example specialist who treat the condition “cerebrovascular accident”. FIG. 9 shows an example of a physicians search results page for physicians who treat the condition “cerebrovascular accident” when the specialist category “Neurologist” is selected by the user from list 802. The physicians shown in list 902 are the neurologists with the highest ranked scores based on their areas of expertise. FIG. 10 is an alternative example further showing each physician's score according to an embodiment of the present invention. List 1002 shows each physician along with their expertise score (here labeled as “Emphasis Match Score”). FIG. 11 is an alternative example of FIG. 9 where “Neurosurgeon” was selected as the specialist category from list 802. List 1102 shows the neurosurgeon specialists who treat “cerebrovascular accidents”.

The schemes described above link medical professionals to medical conditions or procedures based on the professionals level of expertise. By associating areas of expertise to both medical practitioners and conditions or procedures, these schemes effectively use the areas of expertise to bridge between conditions or procedures and the doctors who are best fit to treat the condition or perform the procedure. Assuming that expertise and experience is related to better patient outcome, use of this search technology would be expected to improve patient outcome, and reduce the cost of referrals by reducing the number of referrals to the wrong medical practitioner.

While the present invention has been described using the example and embodiments related to medical specialists, conditions, and procedures, it should be understood that the techniques and principles can be used in other professions to find other professionals that emphasize in certain aspects of the profession.

Although the various aspects of the present invention have been described with respect to particular embodiments, it will be understood that the invention is entitled to protection within the full scope of the appended claims.

What is claimed is:

1. A method of identifying medical professionals having expertise with a condition or procedure, comprising:
assigning areas of expertise to one or more conditions or procedures;
assigning areas of expertise to one or more professionals;
receiving a description for which treatment is desired;
subsequently identifying a condition or procedure based on the received description;
upon identification of the condition or procedure, retrieving areas of expertise assigned to said condition or procedure; and
identifying professionals assigned to one or more of the retrieved areas of expertise for said condition or procedure.

2. The method of claim 1, wherein assigning areas of expertise comprises assigning medical specialties as defined by a medical organization.

3. The method of claim 1, wherein assigning areas of expertise comprises assigning medical sub-specialties as defined by a medical organization.

4. The method of claim 1, wherein assigning areas of expertise comprises assigning areas of emphasis as defined by individual medical professionals.

5. The method of claim 4, wherein areas of emphasis assigned to a given professional are selected by the professional from a list of areas of emphasis.

6. The method of claim 1, wherein assigning areas of expertise comprises assigning to a given professional conditions or procedures that have assigned areas of expertise which are also assigned to the professional.

7. The method of claim 1, further comprising allocating a percentage of effort to one or more areas of expertise assigned to a given professional.

8. The method of claim 1, wherein the description is a query comprised of search terms for searching a database of medical conditions or procedures.

9. The method of claim 8, further comprising expanding the query with additional search terms that are similar to the original search terms.

10. The method of claim 8, further comprising replacing the query with a second similar query, wherein similarity is based on the number of search terms the two queries have in common.

11. The method of claim 1, wherein identifying professionals comprises:
organizing the retrieved areas of expertise into one or more categories;
assigning to each of the one or more categories a numerical category weight; and
calculating a numerical score for each identified professional, wherein the calculation comprises:
(1) assigning a unit value to every area of expertise the professional has in common with the identified condition or procedure;
(2) calculating for each category a category score equal to the sum of the unit values for all areas of expertise in said each category;
(3) multiplying each category score by its assigned category weight; and
(4) summing all weighted category scores to generate a single numerical score for the professional; and
sorting the identified professionals by their numerical scores.

12. The method of claim 11, further comprising pre-determining a minimum score and removing all identified professionals who have numerical scores less than the minimum score.

13. The method of claim 11, further comprising:
grouping the identified professionals by the categories;
calculating a statistical distribution for each group of identified professionals; and
eliminating physicians from the groups based on the statistical distribution for each group.

14. The method of claim 11, wherein the category weights for categories containing areas of emphasis are greater than the category weights for categories containing areas of expertise that are defined by medical organizations.

15. The method of claim 14, wherein the category weights for categories containing areas of expertise that are conditions are greater than all other category weights.

16. The method of claim 11, wherein the unit value for each area of expertise that has an allocated a percentage of effort is scaled by that percentage of effort.

17. A method of scoring medical professionals on their level of expertise with a condition or procedure, comprising:
creating condition or procedure links between conditions or procedures and medical professionals who treat the condition or perform the procedure;
creating medical specialty links between conditions or procedures and medical professionals who specialize in treating the condition or performing the procedure;
creating medical sub-specialty links between conditions or procedures and medical professionals who sub-specialize in treating the condition or performing the procedure;
creating emphasis links between conditions or procedures and medical professionals who emphasize treating the condition or performing the procedure;
identifying a condition or procedure based on a description received by an entity wishing to identify a medical professional to treat the condition or perform the procedure; and
subsequently retrieving professionals who are linked to said condition or procedure.

18. The method of claim 17, further comprising calculating a numerical score for each retrieved professional, wherein the calculation for a given professional comprises:
assigning a condition or procedure link score to any condition or procedure link between the professional and the condition or procedure;
calculating a medical specialty links score that is equal to the number of medical specialty links between the professional and the condition or procedure;
calculating a medical sub-specialty links score that is equal to the number of medical sub-specialty links between the professional and the condition or procedure;
calculating an emphasis links score that is equal to the number of emphasis links between the professional and the condition or procedure; and
summing the condition or procedure links score, the medical specialty links score, the medical sub-specialty links score, and the emphasis links score to generate a single numerical score for the professional.

19. The method of claim 18, wherein:
assigning a condition or procedure link score further comprises multiplying the condition or procedure link score by a condition or procedure links weight;
calculating a medical specialty links score further comprises multiplying the medical specialty links score by a medical specialty links weight;
calculating a medical sub-specialty links score further comprises multiplying the medical sub-specialty links score by a medical sub-specialty links weight; and
calculating an emphasis links score further comprises multiplying the emphasis links score by an emphasis links weight.

20. The method of claim 19, wherein the condition or procedure links weight is greater than the emphasis links weight, the emphasis links weight is greater than the medical sub-specialty links weight, and the medical sub-specialty links weight is greater than the medical specialty links weight.

21. A method of identifying medical professionals who emphasize their professional skills in treating a condition or performing a procedure, comprising:
creating categories of different areas of professional emphasis;
connecting medical professionals to conditions or procedures where a given professional has assigned an area of emphasis that treats the condition or performs the procedure;
receiving a description;
associating the received description with a condition or procedure from a taxonomy of procedures and conditions;
identifying medical professionals who are connected to the associated condition or procedure by one or more areas of professional emphasis; and
calculating a numerical score for each identified professional equal to the number of areas of professional emphasis that connect the professional to the condition or procedure.

22. The method of claim 21, wherein the areas of emphasis assigned to a professional is created by the professional.

23. The method of claim 21, wherein the areas of emphasis assigned to a professional is selected by the professional from a list of areas of emphasis that is specified based on the professional's medical training and board certification.

24. The method of claim 21, further comprising assigning one or more affiliations to one or more medical professionals.

25. A computer system for identifying medical professionals having expertise with a condition or procedure, comprising:
a database of medical professionals;
a database of conditions and procedures;
means for selecting a condition or procedure by an entity wishing to select a medical professional to treat the condition or perform the procedure; and
means for determining which professionals specialize in treating the selected condition or performing the selected procedure.
